(19) United States
(12) Patent Application Publication
(10) Pub. No.: US 2009/0192905 A1
(43) Pub. Date: Jul. 30, 2009

(54) SELF SERVICE ORDER PROCESSING SYSTEM AND METHOD WITH A REMOTE RECEIPT PRINTER

(75) Inventors: David J. Oles, San Marcos, TX (US); Serge Deschamps, Chilly Hazarin (FR)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: DNP PHOTO IMAGING AMERICA CORPORATION, San Marcos, TX (US)

(21) Appl. No.: 12/363,548

(22) Filed: Jan. 30, 2009

Related U.S. Application Data
(60) Provisional application No. 61/024,885, filed on Jan. 30, 2008.
(60) Provisional application No. 61/137,838, filed on Aug. 4, 2008.

(51) Int. Cl. G06Q 30/00; G06Q 20/00; G06Q 50/00

(52) U.S. Cl. 705/17; 705/24; 705/16

(57) ABSTRACT

The present invention provides a system of order fulfillment that utilizes an order station, a separate fulfillment station, and a separate payment station. The order station presents the consumer with options for placing an order and upon the consumer's completion of the order issues a fulfillment receipt for the order. The consumer pays for the order at the order station, the separate payment station, or the fulfillment station. The consumer then presents the fulfillment receipt at a fulfillment station where the order is fulfilled and provided to the consumer.

### CROSS-REFERENCE TO RELATED APPLICATIONS

This application claims the benefit under 35 U.S.C. § 119(e) of U.S. Provisional Application No. 61/024,885 entitled “SELF SERVICE ORDER PROCESSING SYSTEM AND METHOD” filed on Jan. 30, 2008, and 61/137,838 entitled “SELF SERVICE ORDER PROCESSING SYSTEM AND METHOD WITH A REMOTE RECEIPT PRINTER” filed on Aug. 4, 2008, both of which are incorporated herein by reference in their entireties.

### BACKGROUND OF THE INVENTION

### Field of the Invention

This invention relates to self-service processing and fulfillment of orders for consumer products, and more particularly to a system and method for processing and fulfilling a consumer's order for one or more consumer products, such as an order for printed photographs, from separate self-service processing devices.

### DESCRIPTION OF THE BACKGROUND

Self service devices are increasing in popularity among consumers in a variety of retail applications. For instance, consumers often have the option of using a self-service checkout system at retail locations to scan items they have selected for purchase, operate the payment system to submit their payment, bag their products, and collect their change and receipt, all without interacting with employees of the retail establishment. Likewise, self-service kiosks are available to allow a consumer to engage a product selection system, remit payment for their product, and in some cases even receive the product from the self-service kiosk. One particular example of such self-service kiosk is a system for processing a consumer's order for photographic prints in which the consumer engages the system to select photographs to be printed from the consumer's own digital media, submit payment for their order, and receive the photographs from the kiosk.

Unfortunately, while such a self-service system provides some degree of convenience for the consumer, as the increasing popularity of such self-service kiosks attracts more and more consumers, their use can become more of a hindrance than a convenience. Specifically, in the event that more than one person at a time wishes to have their order processed, each person must wait for the others ahead of them in line to not only configure and pay for their order, but also for the kiosk itself to process the user's order. Even if the single kiosk provides multiple user interfaces to allow more than one consumer to engage the system at one time, the output from such kiosk would become too difficult to manage (with parts of multiple orders becoming intermixed with one another) to make such application practical.

Moreover, while such devices can provide some measure of convenience for the consumer, the amount of administrative effort required to integrate such systems with the retail establishment's point of sale (“POS”) systems can be so significant as to outweigh the benefits the retail establishment might receive from providing such convenience to its consumers.

Additionally, the benefit of self-service order processing and fulfillment systems can have widespread appeal, such that a single self-service kiosk or station may need to be able to process orders from consumers of varied backgrounds, and particularly from consumers that speak different languages. To maximize the usefulness of such self-service order processing and fulfillment systems, it would be desirable to provide an interface that could adapt to the consumer user's language with minimal effort on the part of the consumer to make a particular language selection.

Thus, a need exists to provide a system and method that allows for the simultaneous, self-service processing of product orders from multiple consumers, and the self-service fulfillment of such orders, in as efficient and timely a manner as possible while minimizing the effort and system modifications necessary to integrate with the retail establishment's POS system.

### SUMMARY OF THE INVENTION

The present invention provides an order fulfillment system that allows a user to place an order for a specific item at an order station and retrieve it at a separate fulfillment station. The specific items to be ordered include photographic prints, DVDs, CDs, and other digital media products. In one embodiment of the present invention, the system comprises an order station, a separate fulfillment station, and a separate payment station. The customer may place the order at the order station and receive a receipt validating payment of their order. The customer then presents the receipt at the fulfillment station, which fulfills and delivers the order to the consumer. The order station may print a cash receipt that the customer may take to a payment station for payment. Once the customer pays at the payment station, the order is marked as paid and the customer may proceed to retrieve his or her order from the fulfillment station. Alternatively, the system may simultaneously print a cash receipt at the order station and a fulfillment receipt at the payment station. Upon payment of the order, the consumer may be provided with the fulfillment receipt to be used at the fulfillment station and retrieve his or her order.

The present invention also provides for an order fulfillment method at, for example, a retail location, consisting of a number of steps. In one step an order station presents a user with a number of options to interact with an order station. Such options may include the language to be utilized in interacting with an order fulfillment system; entering information to identify the order; uploading digital images, files, and other order items onto the system. In another step, the system receives payment from the customer. In a separate step, the order station prints a receipt that may be recognized by the separate payment station and/or the fulfillment station. The fulfillment station, in yet a separate step, recognizes the receipt for fulfillment of the order and provides the product to the consumer. In some further embodiments of the present invention, some additional steps may be provided. The order station may print a cash receipt to facilitate payment at a payment station. The cash receipt may be read at the payment station and upon payment the order may be marked as paid. The payment station may then print a fulfillment receipt. The fulfillment receipt is read at the fulfillment station and the order is fulfilled. The cash and fulfillment receipts may also be printed simultaneously at the order station (cash receipt) and the payment station (fulfillment receipt). Upon payment at the payment station, the consumer is provided with the fulfillment receipt for fulfillment of his or her order. In a further embodiment of the present invention, a computer usable product having a computer program adapted to execute the fulfillment method described above is provided.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a schematic diagram of a system in accordance with one embodiment of the present invention.

FIG. 2 is a flow chart of a method in accordance with one embodiment of the present invention.

FIG. 3 is a flow chart of a method in accordance with one embodiment of the present invention.

### DETAILED DESCRIPTION

The invention summarized above may be better understood by referring to the following description, which should be read in conjunction with the accompanying claims and drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

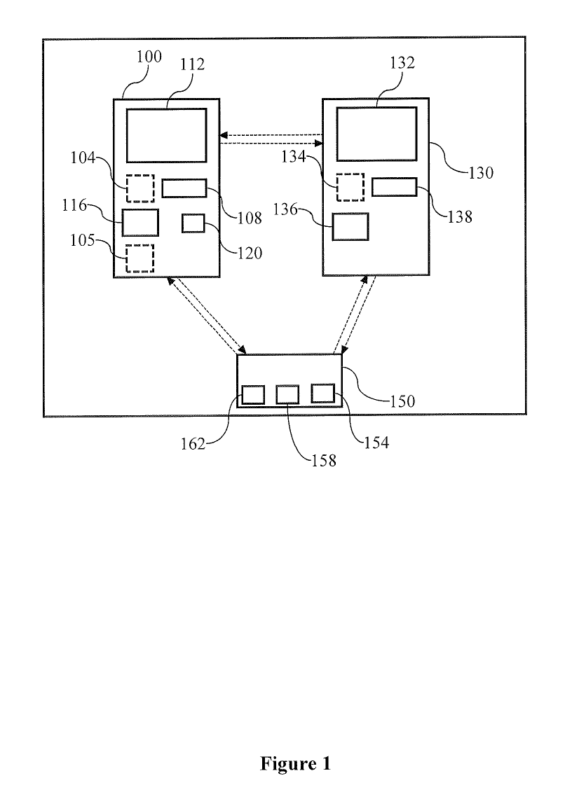

According to a first aspect of a particularly preferred embodiment of the invention, as shown in FIG. 1, a self service order processing system preferably comprises an order station 100 and a fulfillment station 130. The fulfillment station 130 may be located at a different location from the order station 100. The order station 100 and the fulfillment station 130 may be in communication directly between one another or through a network, such as a personal area network (PAN), a local area network (LAN), a campus area network (CAN), a metropolitan area network (MAN), a wide area network (WAN), a global are network (GAN), a virtual private network (VPN), a wireless network, an intranet, an extranet, or an internet. The order station 100 and fulfillment station 130 may also be in communication with a payment station 150.

As shown in FIG. 1, the order station 100 preferably includes a processing unit 104 in communication with a media reader 108, a user interface 112, a payment processing unit 116, a receipt printer 120, and a storage medium 105. The user interface 112 may comprise any means understood by a person of ordinary skill in the art to allow a user to interact with the order station 100. For example, user interface 112 may be a touch screen that allows a user to make necessary selections, a combination of a screen and a keyboard, or a voice recognition component that allows a user to make his or her selections by speaking to the order station 100. The user interface 112 allows the user to enter and upload data in the form of text messages and/or graphic images. In one preferred embodiment, the order station 100 is preferably a self service kiosk. The processing unit 104 of the order station 100 may include a set of instructions in computer readable form that allows the order station 100 to receive orders for particular consumer products from a user. One such order may be, by way of non-limiting example, an order to purchase photographic prints from the user's collection of digital images on a digital storage device that can be uploaded to the order station 100 through the media reader 108. Other examples may include music, video and other media files the consumer wishes to prepare as a single product. For example, the user may provide digital music files to be written onto a CD or video files to be written onto a DVD or similar device.

Alternatively, the order station 100 may be a remote computer, such as a computer located somewhere other than the retail establishment where the order is to be fulfilled. For instance, such remote computer may comprise the consumer's own personal computer located at their residence, workplace, or any other such location having connectivity to a wide area network, such as the Internet, to allow communication with the retail establishment, the order station 100 and/or the fulfillment station 130. It is noted that, without departing from the spirit and scope of the instant invention, the order station 100 need not be located at the retail establishment at which the fulfillment station 130 is located, and instead may be any networked computer terminal, including a computer at the customer user's own home or office having Internet connectivity or an order station kiosk located at another retail establishment.

The payment processing unit 116 may comprise a cash payment acceptance device, a credit card payment acceptance device, gift card payment acceptance device, or any other type of payment acceptance device recognized by a person of ordinary skill in the art. In some embodiments of the present invention, the order station 100 may have only one payment acceptance device, such as a credit card payment device. In such embodiments, the order station 100 may be in communication with a retail establishment's payment station 150 and/or POS system to receive cash payments. It is contemplated that in some instances the order station 100 may not have any payment acceptance devices.

The order station 100 may also include or be in communication with a storage medium 105, such as a system server, cache memory, and similar devices. The storage medium 105 may be utilized to store details concerning the particular order to be processed. The storage medium 105 may also be accessed by the fulfillment unit 130 in order to retrieve order information necessary to complete the user's order. The storage medium 105 may also be accessed by the payment station 150 in order to process payment of the order and provide payment information to the fulfillment station 130.

In one preferred embodiment, the order station 100 includes a receipt printer 120 that prints receipts for order fulfillment. The receipt printer 120 may print fulfillment receipts or cash receipts. The receipt may include identification characteristics that allow the payment station 150 and/or fulfillment station 130 to recognize the receipt and the order to which the receipt refers. Some examples of such identification characteristics may include an alphanumeric code, a radio frequency (RF) transponder tag, and encoded magnetic stripe, a barcode and any other such identifiable characteristics recognized by a person of ordinary skill in the art. The fulfillment receipts and cash receipts contain information about a particular user's order. The fulfillment receipt can be presented at the fulfillment station 130 for order fulfillment while the cash receipt is to be presented at the payment station 150 for payment. A second receipt printer 154 may also be provided, which is in communication with the order station 100 but located in a different site. For example, the second receipt printer 154 may be located at a payment station 150 behind the counter at one of the retail establishment's cash registers. The second receipt printer 154 may be in direct communication with the order station 100 through a wireless receiver, the retail establishment's network, or any other means understood by a person of ordinary skill in the art to allow communication between the order station 100 and the second receipt printer 154. The second receipt printer 154 may also be in communication with the retail establishment's POS system in order receive confirmation of payments received at the payment station 150. In one exemplary embodiment, the receipt printer 120 prints a cash receipt and the second receipt printer 154 prints a fulfillment receipt simultaneously. When a consumer presents the cash receipt to a clerk at the payment station 150 and pays for the order, the clerk may provide the consumer with the pre-printed fulfillment receipt.

The fulfillment station 130 preferably includes a fulfillment processing unit 134 in communication with one or more order preparation devices 138, a fulfillment user interface 132, and a receipt reader 136. The order preparation device 138 may include, for example, a photograph printer, a CD drive capable of recording files onto a CD, a DVD drive capable of recording files onto a DVD, a USB drive capable of delivering files to a digital media device and any other device that enables the fulfillment station 130 to deliver the order to the consumer. The fulfillment user interface 132 may comprise any means understood by a person of ordinary skill in the art to allow a user to interact with the fulfillment station 130. For example, fulfillment user interface 132 may be a touch screen that allows a user to make necessary selections, a combination of a screen and a keyboard, or a voice recognition component that allows a user to make his or her selections by speaking to the fulfillment station 130. The fulfillment processing unit 134 of the fulfillment station 130 may include a set of instructions in computer readable form that allows the fulfillment station 130 to complete and deliver an image order placed at the order station 100. One such order may be, by way of non-limiting example, an order to purchase photographic prints from the user's collection of digital images stored on a digital storage device that was uploaded onto the order station 100 through the media reader 108.

The fulfillment station 130 may also be connected to the network to which the order station 100 is connected such as a personal area network (PAN), a local area network (LAN), a campus area network (CAN), a metropolitan area network (MAN), a wide area network (WAN), a global are network (GAN), a virtual private network (VPN), a wireless network, an intranet, an extranet, and an internet. The fulfillment station 130 may have access to the storage device at which the order items are stored through a network as described above. In some embodiments of the present invention, the fulfillment station 130 is also enabled to accept payment for said order upon presentation of the receipt printed at the order station 100.

In one preferred embodiment of the present invention, the fulfillment station 130 is a self service kiosk which may be located at a retail establishment, and is configured to fulfill a consumer's order entered at the order station 100. Such fulfillment station 130 preferably includes a receipt reader 136. The receipt reader 136 may be a barcode scanner, text reader with optical character recognition capability, an RF transponder reader, a magnetic head for recognition of magnetic stripe information, or other similarly configured reader device capable of reading a barcode or other indicia on the user's receipt created by the order station 100 to identify the user's order and, in turn, retrieve the details of such order for fulfillment. The order details are preferably stored on storage medium 105, such as a system server, cache memory or any other storage device as previously described. Order information may include language information and the details of the user's order in order to allow the fulfillment unit 130 to receive input from the user.

The system of the present invention may also include a payment station 150 enabled to authorize fulfillment of the order by the fulfillment station 130. The payment station 150 may be a customer service counter, a self service POS terminal, or a similar location separate from the order station 100, where the customer may process payment of the order. The payment station may include a second receipt reader 158 similar to the receipt reader 136 utilized at the fulfillment station 130. The payment station may also include a second receipt printer 154 in communication with the order station 100, the fulfillment station 130 and the retail store's POS system. In some embodiments of the present invention, it is contemplated that the second receipt printer 154 may only be in communication with at least one of the order station 100, the fulfillment station 130, and the retail store's POS system.

The payment station 150 may also include a payment acceptance device 162 for processing payments from the customer. The payment acceptance device may include a cash register, a credit card reader, gift card reader, and debit card reader and other such devices recognized by a person of ordinary skill in the art to accept payment. The second receipt reader 158 is preferably connected to a network at the retail establishment monitored by the fulfillment station 130, or alternatively by an application residing on a computer system in the customer service area accessible to employees of the retail establishment at which the fulfillment station 130 is located. Such network may include a personal area network (PAN), a local area network (LAN), a campus area network (CAN), a metropolitan area network (MAN), a wide area network (WAN), a global are network (GAN), a virtual private network (VPN), a wireless network, an intranet, an extranet, or an internet. The second receipt reader 158 may be connected to the network preferably using a wireless (wifi, Bluetooth, etc.), wired means such as a LAN, or any other network enabled for use with the system as previously described.

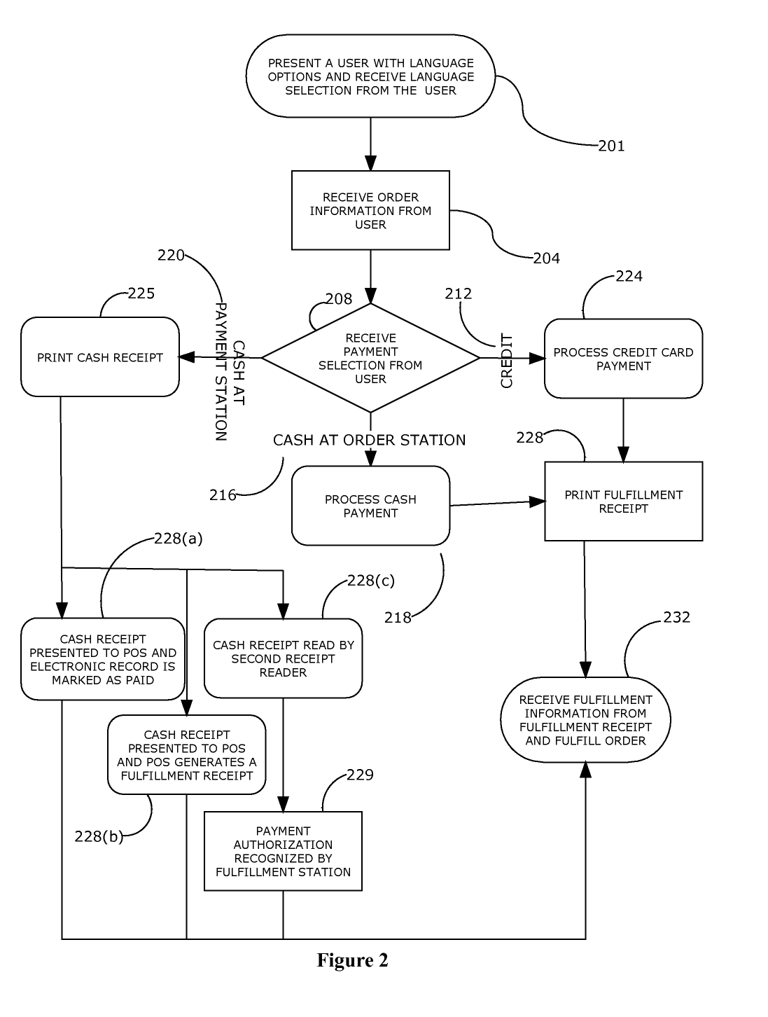

The system described above can be utilized to implement a method of fulfilling customer's orders in accordance with a preferred embodiment of the present invention as described in FIG. 2. In a first step 201, the order station 100 presents a user with a number of choices to select the language in which the user prefers to engage the functions of the order station 100. Optionally, in addition to allowing the consumer to select their preferred language, the order station 100 may prompt the consumer to input additional identifying information. For example, the order station 100 may prompt the consumer to input their email address and the last four digits of their phone number, and use such data as an identifier for that particular consumer, electronically associating that user's language preference, order details, and any other information that the order station 100 collects from the user, with that particular consumer. Of course, other information can be collected from the consumer and used to identify such consumer's order without departing from the spirit and scope of the instant invention. It is contemplated that the additional identifying information may be collected at step 201 upon engagement of the order station 100 or during step 204 as described below. Some of the identifying information collected by the order station 100, such as e-mail address and/or last four digits of the user's phone number, may be utilized in the event that the user misplaces his or her fulfillment receipt or cash receipt.

Upon receipt of the input from the user at step 201, the order station 100 provides the consumer with a number of options to prepare his or her order in step 204. Such information may include, for instance (in the exemplary context of a digital image order processing system), image data for a collection of images they wish to print, selection of numbers of prints they wish to print for each image, image processing information (e.g., red eye reduction, contrast adjustment, etc.), and any other information desirable or necessary in order to process the consumer's order. During this input step 204, the consumer may also upload his or her images from a media storage device through the media reader 108. The user may also upload the images from storage locations accessible to the order station 100. For example, when the user is placing an order through the Internet from home, where the order station is the user's computer, the images may be uploaded directly from the user's computer. In yet another example, the user may select music files from storage media made available to the order station 100, from a preloaded selection on the order station 100, or from an Internet page accessible to the order station 100. The user may also upload digital video files through the media reader 108 for DVD product purchases. It is contemplated that during this step 204, the user may provide or select any such digital file understood by a person of ordinary skill in the art to be capable of being incorporated into the product to be provided by the fulfillment station 130.

After the consumer has input sufficient data to configure the product order, the order station 100 may prompt the consumer to input payment information at step 208. With regard to one aspect of a particularly preferred embodiment, the order station 100 may prompt the user to input a selection of payment with a credit card or gift card at step 212, payment with cash at the order station 100 at step 216, or payment with cash at a payment station 150 at step 220. If the user elects at step 212 to pay with a credit card, credit card payment processing software at the order station 100 processes the user's credit card payment information at step 224, in accordance with electronic payment processing methods that are well known in the art and thus will not be further addressed here. Similarly, if the user selects to pay by cash at the order station 150 at step 216, the order station processes the cash payment at step 218 using regular methods recognized by those of ordinary skill in the art. After the user's credit card payment or cash payment at the order station has been processed, the order station 100 generates a fulfillment receipt at step 228 including one or more indicia such as a bar code, printed alpha numeric information, or other data referencing the user's order so that the details of such order may be retrieved for fulfillment by the fulfillment station 130. It is to be understood that the fulfillment receipt may include multiple indicia identifying the user's order. The fulfillment receipt may contain a specific code that indicates to the fulfillment station 130 that the order has been paid and also includes identification characteristics that designate a particular order as being associated with the specific receipt. Alternatively, the order information stored electronically by the order station 100 and accessible by the fulfillment station 130 may indicate that payment has been made, thus allowing the fulfillment station 130 to complete the order once the fulfillment receipt is read at the fulfillment station 130.

If at step 220 the user selects payment with cash or a credit/debit card or a gift card at a payment station 150, the order station 100 prints a cash receipt at step 225 containing some of the information required for fulfilling the order, and the order station 100 then directs the user to proceed to a payment station 150. The electronic record for such order is preferably marked as having not yet been paid. Alternatively, the order station 100 may print a cash receipt at step 225 similar to the fulfillment receipt, which may also include an order summary or other indicia that indicates that the order has not yet been paid. For instance, the cash receipt may include a numeric code indicating a specific order number and a payment status indicator. By way of an illustrative example, the order number and payment status indicator may be comprised of ten digits where the first number is a payment indicator and the remaining nine numbers are reserved for the order number. In such a system, for example, the cash receipt for unpaid order “100” will include the following serial number: 1000000100, where the first “1” in the code signifies that the customer has not paid for the order. The remaining digits in the code could likewise be reserved for additional embedded information. It is contemplated that in some embodiments of the present invention, the electronic record for the order is marked as unpaid and the cash receipt further includes the payment code described above. Other forms of payment indicators include bar codes and encryption codes commonly recognized by a person of ordinary skill in the art to provide such information for the payment station 150 and the fulfillment station 130. In yet a further embodiment of the present invention, once cash or credit at the payment station is selected, the receipt printer 120 may print a cash receipt and simultaneously the second receipt printer 154 at the payment station 150 may print the fulfillment receipt. When the costumer presents the cash receipt at the payment station 150 and pays for the order, the fulfillment receipt is provided to the consumer for fulfillment of the order. This simultaneous receipt printing approach may not require the electronic order file to be flagged and/or any interaction with the retail establishment's POS system.

The user may then visit the payment station 150, for example a customer service counter or self service POS terminal 162 and present the cash receipt and pay for their order. Payment at the payment station 150 may be processed in a number of different ways as described by way of non-limiting examples with reference to steps 228(a) through 228(c).

In one embodiment, as described at step 228(a), the cash receipt is presented at the payment station 150 to a retail establishment employee or self service POS terminal 162. Upon payment at the payment station, the POS software of the retail establishment through, preferably, an XML application programming interface marks the order's electronic record as paid. The cash receipt can then be presented as a fulfillment receipt at the fulfillment station 130, which will recognize the order as paid upon retrieval of the electronic record for the order.

In another embodiment, as described at step 228(b), a customer service agent or the user may present the cash receipt to a POS terminal capable of reading the cash receipt. Upon payment, the POS software may generate a fulfillment receipt through a second receipt printer 154 at the payment station 150 having a different encoding from the cash receipt generated by the order station 100. For example, using the numbering scheme described above, the fulfillment receipt may be encoded as 0000000100 for order #100, with the “0” in the initial digit place indicating that the order has been paid. Once the fulfillment receipt has been generated, the cash receipt may be discarded. Preferably, the retail establishment's POS system is configured in this case to read the cash receipt containing a non-payment encoded indicia and then generate a fulfillment receipt containing a payment encoded indicia.

In yet a further embodiment, as described at step 228(c), the user takes the cash receipt to a payment station 150 and presents it to an employee of the retail establishment or to a second receipt reader 158 at the payment station 150. If presented to an employee, the employee may present the cash receipt to the second receipt reader 158. Upon payment of the order at the payment station 150, the order is marked as paid on the electronic file. In one alternative of the present invention, the employee may enter a validation code into the system marking the electronic file of the order as paid. As further alternative, the employee may utilize a web application to enter the order details from the cash receipt and provide a valid payment code. The validation codes for validation of payment may be generated by the order station 100 and printed on the cash receipt. In an alternative example, employees may have access to discrete and predetermined validation codes that may be utilized for multiple orders. In a further alternative example, the employee may also present a validation card containing validation of payment indicia to the second receipt reader 158.

The fulfillment station 130 recognizes the payment authorization through the network at step 229. Once the validation code, or validation indicia, is recognized by the system, the order is marked as paid. The cash receipt may then be used at the fulfillment station as a fulfillment receipt. This configuration may be particularly well adapted to use in environments where it is desirable to eliminate modifications to or integrations with a POS system, as none is required in order to process and fulfill the user's order.

At a subsequent step 232, the user may return to the fulfillment station 130 and present the fulfillment receipt. The fulfillment station 130 preferably determines the user's language from step 201 (as indicated in the customer user's order profile associated with the fulfillment receipt), and automatically switches the language used at the fulfillment station 130 to match the user's language. More specifically, once the user has received such fulfillment receipt, he or she leaves the order station 100 and may proceed to the fulfillment station 130. After reading the barcode or other indicia on the receipt, the fulfillment station 130 preferably automatically switches to the language that the customer used during their interaction with the order station 100, unless such user's language selection is already in use by the fulfillment station. The customer's email address and the last 4 digits of their telephone number, or such other identifying information as the order station may have collected from the user, can be used at the fulfillment station to process and release previously generated orders if the user happens to lose the original printed and bar-coded or otherwise marked receipt. The fulfillment station 130 reads the fulfillment receipt through a receipt reader 136. If the user presents a cash receipt instead of the fulfillment receipt, which has not been authorized for processing through any of the previously mentioned steps, the fulfillment station 130 may direct the user back to the payment station 150. The fulfillment station 130 may also notify the user that the order has not been paid.

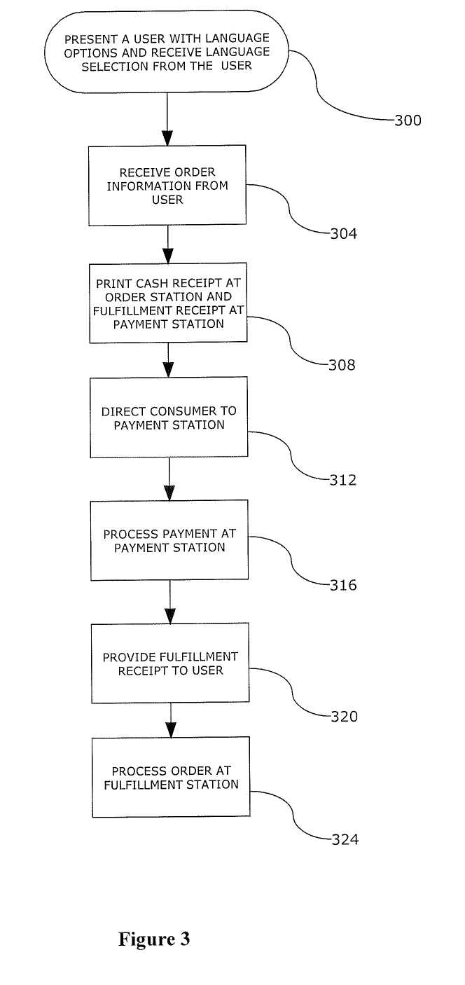

In situations where the order station 100 does not have a payment processing unit, another preferred embodiment of the method as described in FIG. 3 may be utilized. In a first step 300, the order station presents the user with options to select a language and/or to enter other identification information as discussed previously. In step 304, the customer places an order. In step 308, when the user finishes placing an order, the order station 100 prints a cash receipt that contains the order number and details of the order but that may not be recognized by the fulfillment station 130. At the same time the cash receipt is printed at the order station 100, a fulfillment receipt as previously described is printed at a remote receipt printer 154 in communication with the order station 100 through a wireless or wired connection. It is contemplated that the retail establishment utilizing this arrangement may utilize wireless or wired printers to print the fulfillment receipt behind a counter. Retailers utilizing wireless systems do not need to integrate the printer into their network. If a wired printer is utilized, the retailer may integrate the printer into the store network or a system network for order fulfillment. For additional security, the bar code format may be encrypted or disguised. In a subsequent step 312, the user is directed to a payment station 150 where the remote receipt printer 154 (or second receipt printer) is located. At step 316, the user presents the cash receipt to the customer service agent at the payment station 150, and pays for their order. The user is provided the fulfillment receipt that can be read by the fulfillment station 130 from the remote receipt printer 154, at step 320.

At step 324, the user may then go or return to the self service fulfillment station 130 and present the fulfillment receipt and the order is processed as previously described in FIG. 2. The fulfillment station 130 reads the fulfillment receipt through a receipt reader 136. The fulfillment station 130 preferably determines the user's language (as indicated in the customer user's order profile associated with the fulfillment receipt), and automatically switches the language used at the fulfillment station 130 to match the user's language as previously selected at the order station 100. If the user presents a cash receipt instead of the fulfillment receipt, which has not been authorized for processing through any of the previously mentioned steps, the fulfillment station 130 may direct the user back to the payment station 150. The fulfillment station 130 may also notify the user that the order has not been paid.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. An order fulfillment system, comprising:
an order station,
a separate fulfillment station, and
a separate payment station; wherein said order station, said separate fulfillment station, and said separate payment station are communicatively connected with each other.

2. The system of claim 1, wherein said order station comprises:
a user interface,
a media reader,
a receipt printer, and
a storage medium.

3. The system of claim 1, wherein said fulfillment station comprises:
a user interface,
a receipt reader, and
an order preparation device.

4. The system of claim 1, wherein said payment station comprises:
at least one of a second receipt reader, a payment acceptance device, or a second receipt printer.

5. The system of claim 4 wherein said second receipt printer is communicatively connected with at least one of the order station, a POS system, a network, or the fulfillment station.

6. The system of claim 4, wherein said second receipt reader is communicatively connected with at least one of the order station, a POS system, a network, or an authorization device.

7. The system of claim 2, wherein said storage device is communicatively connected with the fulfillment station.

8. The system of claim 1, wherein said fulfillment station is enabled to retrieve an order item from said storage device and deliver an order using said order preparation device.

9. The system of claim 2, wherein said storage device is located on a network accessible to at least one of said order station, said fulfillment station, or said payment station.

10. The system of claim 4, wherein said payment acceptance device is enabled to process at least one of a credit card, debit card, gift card, or cash payment.

11. The system of claim 2, wherein said receipt printer is enabled to provide a receipt bearing an identification characteristic.

12. The system of claim 11, wherein said identification characteristic is selected from the group consisting of an alphanumeric code, a radio frequency transponder tag, an encoded magnetic stripe, and a barcode.

13. The system of claim 11, wherein said payment station and said fulfillment station are enabled to recognize said identification characteristic and retrieve an order detail from said order station.

14. The system of claim 11, wherein said payment station is enabled to authorize fulfillment of an order by said fulfillment station.

15. The system of claim 1, wherein said order station is enabled to interact with a user in a language selected by said user.

16. The system of claim 15, wherein said fulfillment station is enabled to interact with said user in said selected language after recognizing an identification characteristic provided by said order station.

17. The system of claim 1, wherein said order station, said separate fulfillment station, and said separate payment station are connected to a network.

18. The system of claim 17, wherein said network is selected from the group consisting of a personal area network (PAN), a local area network (LAN), a campus area network (CAN), a metropolitan area network (MAN), a wide area network (WAN), a global are network (GAN), a virtual private network (VPN), a wireless network, an intranet, an extranet, and an internet.

19. The system of claim 1, wherein said separate fulfillment station is enabled to accept payment of said order.

20. The system of claim 3, wherein said order preparation device is selected from the group consisting of a printer, a digital photograph printer, a compact disc writer, a DVD writer, a drive for digital storage media, a USB port drive, MP3 compatible device dock, and an IPOD dock.

21. The system of claim 1, wherein said order station comprises a separate computer; wherein said separate computer is selected from the group consisting of a user's home computer, a public access computer, and a work computer communicatively connected to the system.

22. A computer program product, comprising a computer usable medium having a computer readable program code embodied therein, said computer readable program code adapted to be executed to implement an order fulfillment method, said method comprising:
providing one or more options to a user at an order station;
enabling said user to select one or more of said options;
identifying the one or more selections made by said user;
enabling said user to store one or more order items at an accessible storage location;
storing said one or more selections and said one or more order items as an order;
providing a receipt comprising an identification characteristic for said order;
receiving said receipt and identifying said identification characteristic at a payment station;
authorizing said order for fulfillment upon payment at a separate payment station;
receiving a fulfillment receipt comprising said identifying characteristic at a separate fulfillment station;
recognizing said identifying characteristic and matching said identifying characteristic to said order; and
fulfilling said order.

23. The computer product of claim 22, wherein said authorizing step comprises:
accepting payment for said image order, and
marking as paid an electronic image order file accessible to said separate fulfillment station, wherein said receipt is to be recognized as a fulfillment receipt upon completion of said marking step.

24. The computer product of claim 22, wherein said authorizing step comprises:
accepting payment of said image order, and
providing a fulfillment receipt.

25. An order fulfillment method, comprising:
providing one or more options to a user at an order station;
enabling said user to select one or more of said options;
identifying the one or more selections made by said user;
enabling said user to store one or more order items at an accessible storage location;
storing said one or more selections and said one or more order items as an order;
providing a receipt comprising an identification characteristic for said order;
receiving said receipt and identifying said identification characteristic at a payment station;
authorizing said order for fulfillment upon payment at a separate payment station;
receiving a fulfillment receipt comprising said identifying characteristic at a separate fulfillment station;
recognizing said identifying characteristic and matching said identifying characteristic to said order; and
fulfilling said order.

26. The method of claim 25, wherein said authorizing step comprises:
accepting payment for said order, and
marking as paid an electronic order file accessible to said separate fulfillment station, wherein said receipt is to be recognized as a fulfillment receipt upon completion of said marking step.

27. The method of claim 25, wherein said authorizing step comprises:
accepting payment of said order, and
providing a fulfillment receipt.

28. The method of claim 25, further comprising:
providing at least one of an order station, a separate fulfillment station, or a payment station.

29. An order fulfillment method, comprising:
providing one or more options to a user at an order station;
enabling said user to select one or more of said options;
identifying the one or more selections made by said user;
enabling said user to store one or more order items at an accessible storage location;
storing said one or more selections and said one or more order items as an order;
providing a receipt comprising an identification characteristic for said order at said order station and simultaneously providing a fulfillment receipt at a separate payment station;
receiving a fulfillment receipt comprising said identifying characteristic at a separate fulfillment station;
recognizing said identifying characteristic and matching said identifying characteristic to said order; and
fulfilling said order.
